(19) United States
(12) Patent Application Publication
(10) Pub. No.: US 2023/0328700 A1
(43) Pub. Date: Oct. 12, 2023

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/209,498

(22) Filed: Jun. 14, 2023

Related U.S. Application Data
(63) Continuation of application No. PCT/CN2021/141465, filed on Dec. 27, 2021.

(30) Foreign Application Priority Data
Dec. 29, 2020 (CN) 202011592580.X

(51) Int. Cl. H04W 72/0446; H04W 76/20

(52) U.S. Cl. CPC H04W 72/0446; H04W 76/20

(57) ABSTRACT

The present application discloses a method and a device for wireless communications, including receiving a first configuration message; the first configuration message being used for configuring a first timer; and transmitting a first message, the first message being used to determine a first time window set, the first time window set comprising at least one time window; and receiving a first signaling; herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time. The present application helps reduce conflicts.

### CROSS REFERENCE TO RELATED APPLICATIONS

This application is the continuation of the international patent application No. PCT/CN2021/141465, filed on Dec. 27, 2021, and claims the priority benefit of Chinese Patent Application No. 202011592580.X, filed on Dec. 29, 2020, the full disclosure of which is incorporated herein by reference.

### BACKGROUND

### Technical Field

The present application relates to transmission methods and devices in wireless communication systems, and in particular to a method for improving efficiency and reducing interruptions concerning multiple network communications in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LIE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), Proximity Services (ProSe), and Device to Device (D2D), Unlicensed Spectrum communications, and monitoring on UE communication quality, network plan optimization, Non-Terrestrial Network (NTN) and Terrestrial Network (TN), Dual connectivity system, or a system using Sidelink, or combined, radio resource management and multi-antenna codebook selection, as well as signaling design, neighbor management, traffic management and beamforming. Information is generally transmitted by means of broadcast/multicast and unicast, and all these ways are beneficial to fulfilling the above requests and make up an integral part of the 5G system. To enlarge the coverage of the network and improve the system's reliability, information can also be forwarded via relaying. As the capability of a communication terminal gets stronger, the communication terminal can be equipped with one Subscriber Identity Module (SIM) card or multiple SIMs. When using multiple SIMs and connecting to multiple networks, how a transceiving module of the terminal coordinates between different networks becomes a key issue.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

### SUMMARY

When a UE (i.e., user equipment, or terminal/cellphone) needs to be in communication with multiple networks, particularly when using multiple corresponding SIMs, there arises a problem of coordination among the networks. When the UE's own hardcore is not sufficient enough to support its communication with two networks simultaneously, independently, in parallel and free from any influence, if a certain degree of coordination can be provided based on the network assistance or initiated by the UE itself, mutual influence between two networks can be avoided. For instance, when the UE needs communications with another network but the current network also indicates its data transmission or reception, the two networks may be mutually influenced. Some UEs may be equipped with two receivers but with only one transmitter, which means that these UEs may be able to receive signals from two networks simultaneously but can only transmit to one network; there are of course some UEs that can only receive signals from one network at the same time; whatever the case may be, most of such UEs cannot transmit signals to two networks simultaneously. The two SIMs or multiple SIMs of the UE may be provided by different operators, which makes the coordination among the networks very limited, so it is hard to coordinate only depending on the networks, and even worse, for the sake of privacy, it is necessary to forbid the networks from conveying user information to one another. When a UE leaves a network temporarily for a short time for receiving or transmitting in another network, the impact on the current network is acceptable, for instance to update a serving cell in another network. The UE, which is still connected with the network from which it leaves, will not transmit and/or receive data temporarily, but will still be under the control and management of the network. The control and the management include many aspects, for instance the triggering of some events in some cases (e.g., the expiration of a timer), which probably need transmission of some data or reports. However, during its temporary absence from the current network the UE cannot transmit any data or report, and this will lead to some contradictions, which, if not handled properly, are prone to cause the UE's disconnection. By offering a new method of controlling behaviors of the UE during its leave, the present application solves the above problem.

To address the above problem, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, it should be noted that the present application is also applicable to for instance communications of UAV (Unmanned Aerial Vehicle, IoT or IIoT, or scenarios with vehicle-mounted networks, NTN or TN, or UE with Reduced Capability (RedCap UE), or communication scenarios with wearables, where similar technical effects can be achieved. Additionally, the adoption of a unified solution for various scenarios contributes to the reduction of hardcore complexity and costs.

The present application provides a method in a first node for wireless communications, comprising:
receiving a first configuration message; the first configuration message being used for configuring a first timer;
transmitting a first message; the first message being used to determine a first time window set, the first time window set comprising at least one time window; and
receiving a first signaling;
herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, a problem to be solved in the present application includes: when a UE fails to send some radio signals towards two networks simultaneously, it has to make a request to the current network for leaving; the UE can be in communication with a second network as it is leaving, and during its time away, some configurations of the original network, if they trigger the UE's execution of certain events, will have an impact on the communications between the UE and the second network. The present application offers special management over timers for these events or control the UE's behavior, hence the solution to the above problem.

In one embodiment, an advantage of the above method includes: avoiding the conflict between two networks, as well as avoiding problems such as a potential disconnection or extra delay.

Specifically, according to one aspect of the present application, comprising: receiving a second message, the second message comprising a first control timer, where the second message is used for indicating that when the first control timer is in a suspended state the first node is allowed to transmit the first message.

Specifically, according to one aspect of the present application, the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than a first expiration time; the first expiration time is a time determined by the expiration value of the second timer after starting of the second timer.

Specifically, according to one aspect of the present application, the first configuration message comprises a third timer, the third timer being expired within the first time window set;
as a response to the third timer being expired, transmitting a first signal to the transmitter of the first signaling within the first time window set.

Specifically, according to one aspect of the present application, the first event comprises transmitting a second signal; the second signal being used for indicating the first measurement result;
performing a first measurement; the first measurement being used for generating a first measurement result;
the action of canceling executing a first event in the second time window set comprises: to cancel transmitting the second signal and discard the first measurement result.

Specifically, according to one aspect of the present application, comprising: receiving a first conditional reconfiguration;
canceling an evaluation of execution conditions of the first conditional reconfiguration, or, canceling an execution of the first conditional reconfiguration within the first time window set.

Specifically, according to one aspect of the present application, the action of canceling executing a first event in the second time window set comprises: to add the first event to the first pending list;
executing the first event in the first pending list at any time other than the second time window set.

Specifically, according to one aspect of the present application, the first node is a UE.

Specifically, according to one aspect of the present application, the first node is a terminal of Internet of Things (IoT).

Specifically, according to one aspect of the present application, the first node is a relay.

Specifically, according to one aspect of the present application, the first node is a vehicle-mounted terminal.

Specifically, according to one aspect of the present application, the first node is an aircraft.

The present application provides a method in a second node for wireless communications, comprising:
transmitting a first configuration message; the first configuration message being used for configuring a first timer;
receiving a first message; the first message being used to determine a first time window set, the first time window set comprising at least one time window; and
transmitting a first signaling;
herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

Specifically, according to one aspect of the present application, comprising: transmitting a second message, the second message comprising a first control timer, where the second message is used for indicating that when the first control timer is in a suspended state the transmitter of the first message is allowed to transmit the first message.

Specifically, according to one aspect of the present application, the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used by the transmitter of the first message to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than a first expiration time; the first expiration time is a time determined by the expiration value of the second timer after starting of the second timer.

Specifically, according to one aspect of the present application, the first configuration message comprises a third timer, the third timer being expired within the first time window set;
as a response to the third timer being expired, the transmitter of the first message transmits a first signal to the second node within the first time window set.

Specifically, according to one aspect of the present application, the first event comprises transmitting a second signal; the second signal being used for indicating the first measurement result;
the transmitter of the first message performs a first measurement; the first measurement being used for generating a first measurement result;
the action of canceling executing a first event in the second time window set comprises: the transmitter of the first message to cancel transmitting the second signal and discard the first measurement result.

Specifically, according to one aspect of the present application, comprising: transmitting a first conditional reconfiguration;
the transmitter of the first message, canceling an evaluation of execution conditions of the first conditional reconfiguration, or, canceling an execution of the first conditional reconfiguration within the first time window set.

Specifically, according to one aspect of the present application, the action of canceling executing a first event in the second time window set comprises: to add the first event to the first pending list;
the transmitter of the first message executes the first event in the first pending list at any time other than the second time window set.

Specifically, according to one aspect of the present application, the second node is a UE.

Specifically, according to one aspect of the present application, the second node is a terminal of Internet of Things (IoT).

Specifically, according to one aspect of the present application, the second node is a satellite.

Specifically, according to one aspect of the present application, the second node is a relay.

Specifically, according to one aspect of the present application, the second node is a vehicle-mounted terminal.

Specifically, according to one aspect of the present application, the second node is an aircraft.

Specifically, according to one aspect of the present application, the second node is a base station.

Specifically, according to one aspect of the present application, the second node is a cell or cell group.

Specifically, according to one aspect of the present application, the second node is a gateway.

Specifically, according to one aspect of the present application, the second node is an access-point.

The present application provides a first node for wireless communications, comprising:
a first receiver, receiving a first configuration message and a first signaling; the first configuration message being used for configuring a first timer; and
a first transmitter, transmitting a first message; the first message being used to determine a first time window set, the first time window set comprising at least one time window;
herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

The present application provides a second node for wireless communications, comprising:
a second transmitter, transmitting a first configuration message and a first signaling; the first configuration message being used for configuring a first timer; and
a second receiver, receiving a first message; the first message being used to determine a first time window set, the first time window set comprising at least one time window;
herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, compared with the prior art, the present application is advantageous in the following aspects:

Firstly, the method proposed by the present application can prevent the UE from influencing communications with the current network by its behaviors configured in another network when connecting to both networks; in the meantime, the UE's connection with the original network can be always remained; after returning to the original network the UE can resume its behaviors previously configured by the network.

Besides, the method proposed by the present application can select according to various network configurations or events that shall be triggered, and adopt corresponding ways of handling; the handling includes controlling timers and controlling whether to execute events being triggered, as well as continuing executions after returning to the original network, where the controlling of timers is based on the fact that some events are triggered by the expiration of a timer, therefore controlling timers can be seen as an effective method. The present application also proposes the method of determining how to control the timer and how to execute/cancel events according to specific types of events, which contributes to guaranteeing the UE services to the largest extent.

Furthermore, the method provided in the present application can control the UE in leaving the current network as time permits, thus avoiding the uncertainty resulting from some behaviors or an absence during the procedures, as well as streamlining the design of protocols.

Furthermore, the method provided in the present application takes full account of the influence of the length of a timer on the handling of events; a certain timer will expire shortly after returning to the original network, which may still lead to that the UE can hardly process relevant events in a timely manner, so that consideration is paid only to the case of expecting events that can be triggered by an expired timer after having returned to the original network for a period of time, where the original network refers to the network that configures the certain timer mentioned above.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first configuration message, transmitting a first message and receiving a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a first time window set according to one embodiment of the present application.

FIG. 7 illustrates a schematic diagram of a first time window set according to one embodiment of the present application.

FIG. 8 illustrates a schematic diagram of a second time window set according to one embodiment of the present application.

FIG. 9 illustrates a schematic diagram of a third time window set according to one embodiment of the present application.

FIG. 10 illustrates a schematic diagram of a first message being used to determine a first time window set according to one embodiment of the present application.

FIG. 11 illustrates a schematic diagram of a first signaling being used to determine that executing a first event is canceled in a second time window set according to one embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

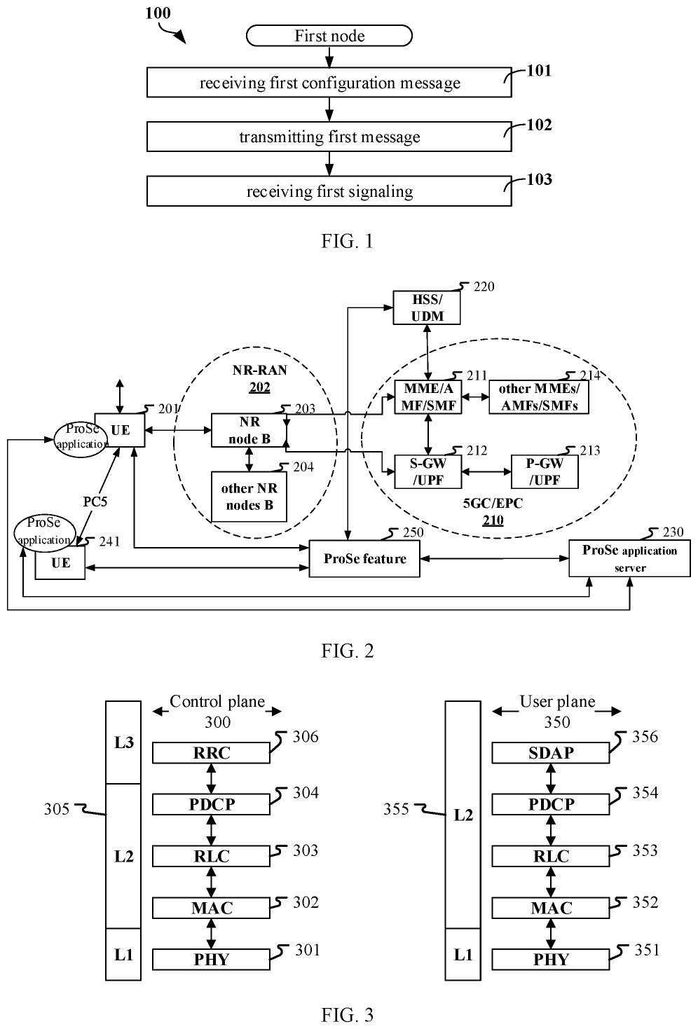

Embodiment 1 illustrates a flowchart of receiving a first configuration message, transmitting a first message and receiving a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first configuration message in step 101; and transmits a first message in step 102; and receives a first signaling in step 103;
herein, the first configuration message is used for configuring a first timer; the first message being used to determine a first time window set, the first time window set comprising at least one time window; and the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the first node is a UE.

In one embodiment, a transmitter of the first signaling is a serving cell of the first node.

In one embodiment, a transmitter of the first signaling is a PCell of the first node.

In one embodiment, a transmitter of the first signaling is a SpCell of the first node.

In one embodiment, a transmitter of the first signaling is a SCell of the first node.

In one embodiment, a transmitter of the first signaling is an MCG of the first node.

In one embodiment, a transmitter of the first signaling is an SCG of the first node.

In one embodiment, a transmitter of the first signaling is a cell on which the first node is camped.

In one embodiment, a transmitter of the first signaling is a network to which the first node connects.

In one embodiment, the first node possesses two SIMs, of which one SIM is for the transmitter of the first signaling; the other is for a second network, the second network being a network other than the transmitter of the first signaling.

In one embodiment, the SIM comprises a Universal Subscriber Identity Module (USIM).

In one embodiment, the SIM comprises an eSIM.

In one embodiment, the SIM comprises a Universal Integrated Circuit Card (UICC).

In one embodiment, the SIM comprises a variety of sizes.

In one embodiment, the SIM is for at least one of {LTE network, 3G network, 4G network, 5G network, 6G network, TN, NTN, URLLC network, IoT network, vehicle-mounted network, IIoT network, broadcast network, unicast network, 3GPP network, Non-3GPP network}.

In one embodiment, the first node has one transmitter and one receiver.

In one embodiment, the first node has one transmitter and two receivers.

In one embodiment, there exists an RRC connection between the first node and the transmitter of the first signaling.

In one embodiment, the first node is in an RRC Connected state relative to the transmitter of the first signaling.

In one embodiment, the first node is in an RRC Connected state relative to the second network.

In one embodiment, the first node is in an RRC Idle state relative to the second network.

In one embodiment, the first node is in an RRC Inactive state relative to the second network.

In one embodiment, the first configuration message comprises an RRC message.

In one embodiment, the first configuration message comprises a NAS message.

In one embodiment, the first configuration message comprises a PC5-RRC message.

In one embodiment, the first configuration message comprises a PC5-S message.

In one embodiment, the first configuration message comprises a SIB.

In one embodiment, the first configuration message comprises a SIB.

In one embodiment, the first configuration message comprises RRCReconfiguration.

In one embodiment, the first configuration message comprises RRCReconfigurationSidelink.

In one embodiment, the first configuration message comprises RRCConnectionReconfiguration.

In one embodiment, the first configuration message comprises RRCConnectionReconfigurationSidelink.

In one embodiment, the first configuration message comprises SpCellConfig.

In one embodiment, the first configuration message is transmitted by means of broadcasting.

In one embodiment, the first configuration message is transmitted by means of unicasting.

In one embodiment, the first timer is a timer.

In one embodiment, the first timer includes at least one of {a T304, a T310, a T312, a T321, a T322, a T380, a T316, a sCellDeactivationTimer, a beamFailureRecoveryTimer, a searchSpaceSwitchTimer, a bwp-InactivityTimer, a periodicB SR-Timer, a phr-PeriodicTimer, a lbt-FailureDetectionTimer, a timer for triggering periodic CSI reporting, a dataInactivityTimer, a timer triggering L2 link ID update, a timer triggering Keep Alive, a discardTimer of PDCP, a t-Reassembly}.

In one embodiment, the first configuration message configures or indicates an expiration value of the first timer.

In one embodiment, an expiration value of the first timer comprises E unit(s), where E is a positive number or a positive integer.

In one subembodiment, the E unit(s) includes(include) at least one of {millisecond, second, an OFDM symbol, a slot, a mini-slot, a sub-frame, a frame, a hyper-frame, minute, a periodicity of Discontinuous Reception (DRX), a paging periodicity, a periodicity of modification, a system message periodicity, a length of time windows in the first time window set}.

In one embodiment, the first signaling comprises configurations of the first timer.

In one embodiment, the first time window set comprises W time window(s), where W is a positive integer.

In one embodiment, time windows comprised in the first time window set are of equal lengths.

In one embodiment, time windows comprised in the first time window set are of unequal lengths.

In one embodiment, time windows comprised in the first time window set are orthogonal in time domain.

In one embodiment, time windows comprised in the first time window set are arranged in order in time domain.

In one embodiment, a time interval between any two time windows comprised in the first time window set is no smaller than time occupied by an OFDM symbol.

In one embodiment, time intervals between any two pairs of adjacent time windows comprised in the first time window set which are adjacent in time domain are mutually equal.

In one embodiment, time intervals between any two pairs of adjacent time windows comprised in the first time window set which are adjacent in time domain are mutually unequal.

In one embodiment, the first message is transmitted via a Uu interface.

In one embodiment, the first message comprises an RRC message.

In one embodiment, the first message comprises an Uplink Control Information (UCI) message.

In one embodiment, a physical channel occupied by the first message includes a Physical Uplink Shared Channel (PUSCH).

In one embodiment, a logical channel occupied by the first message includes a Dedicated Control Channel (DCCH).

In one embodiment, the first message is transmitted using an SRB1 or SRB3.

In one embodiment, the first message comprises at least partial fields in UEAssistanceInformation.

In one embodiment, the first message comprises a UELeavingRequest.

In one embodiment, the first message comprises a UESwitchingRequest.

In one embodiment, the first message comprises a UEShortLeavingRequest.

In one embodiment, the first message comprises a UEAvailablilityIndication.

In one embodiment, the first message comprises a UEInavailablilityIndication.

In one embodiment, the first message comprises a RRCReconfigurationSidelink.

In one embodiment, the first message comprises MCGFailureInformation.

In one embodiment, the first message comprises SCGFailureInformation.

In one embodiment, the first message comprises a ULInformationTransfer.

In one embodiment, the first message is transmitted via a PC5 interface.

In one embodiment, the first message comprises a PC5-RRC message.

In one embodiment, the first message comprises a PC5-S message.

In one embodiment, the transmitter of the first signaling is a base station.

In one embodiment, the transmitter of the first signaling is a serving cell.

In one embodiment, the transmitter of the first signaling is a CellGroup.

In one embodiment, the CellGroup is a Secondary Cell Group (SCG).

In one embodiment, the CellGroup is a Master Cell Group (MCG).

In one embodiment, the first signaling comprises an RRC message.

In one embodiment, the first signaling comprises a Downlink Control Information (DCI) message.

In one embodiment, the first signaling comprises a PC5-RRC message.

In one embodiment, the first signaling comprises a PC5-S message.

In one embodiment, the first signaling comprises a MAC Control Element (CE).

In one embodiment, a physical channel occupied by the first signaling includes a Physical downlink control channel (PDCCH) or a physical downlink shared channel (PDSCH).

In one embodiment, the first signaling comprises a RRCReconfiguration.

In one embodiment, the first signaling comprises a RRCReconfigurationSidelink.

In one embodiment, the first signaling comprises a RRCConnectionReconfiguration.

In one embodiment, the first signaling comprises a RRCConnectionReconfigurationSidelink.

In one embodiment, the first signaling indicates that a request of the first message is accepted/acknowledged.

In one embodiment, the first signaling indicates that a request of the first message for stopping a wireless transmission for a transmitter of the first signaling in the K1 time window(s) is accepted/acknowledged.

In one embodiment, a reception of the first signaling is deemed as the first message being accepted.

In one embodiment, the first signaling indicates the first time window set.

In one embodiment, the first signaling indicates that the first time window set is used for indicating that a request of the first message is accepted.

In one embodiment, the sentence that a wireless transmission for a transmitter of the first signaling be suspended comprises that: the transmitter of the first signaling will not perform uplink and/or downlink scheduling for the first node within the K1 time window(s).

In one embodiment, the sentence that a wireless transmission for a transmitter of the first signaling be suspended comprises that: a scrambling used by radio signal(s) transmitted by the first node U01 within the K1 time window(s) is assigned by a node other than the transmitter of the first signaling.

In one embodiment, the sentence that a wireless transmission for a transmitter of the first signaling be suspended comprises that: neither the transmitter of the first signaling nor an MCG or SCG controlled by the transmitter of the first signaling will perform uplink and/or downlink scheduling for the first node within the first time window set.

In one embodiment, the sentence that a wireless transmission for a transmitter of the first signaling be suspended comprises that: the first node will not perform uplink and/or downlink scheduling for the transmitter of the first signaling within the first time window set.

In one embodiment, the sentence that a wireless transmission for a transmitter of the first signaling be suspended comprises that: the first node is incapable to or will not or fails to receive a radio signal transmitted by the transmitter of the first signaling within the first time window set.

In one embodiment, the first message indicates that the first node can only receive a second-type target signal transmitted by the transmitter of the first signaling within the first time window set.

In one embodiment, the second-type target signal comprises a radio signal bearing broadcast traffics.

In one embodiment, the second-type target signal comprises a radio signal bearing groupcast traffics.

In one embodiment, the second-type target signal comprises a radio signal bearing DCI.

In one embodiment, the second-type target signal comprises a radio signal bearing part of a DCI Format.

In one embodiment, the second-type target signal comprises a paging message.

In one embodiment, the second-type target signal comprises a RRCRelease.

In one embodiment, the second-type target signal comprises a RRCConnectionRelease.

In one embodiment, the second-type target signal comprises a SIB.

In one embodiment, the second-type target signal comprises an Earthquake and Tsunami Warning System (ETWS) signal.

In one embodiment, the second-type target signal comprises any radio signal transmitted by the transmitter of the first signaling.

In one embodiment, the second-type target signal comprises any radio signal associated with a specific CSI-RS which is transmitted by the transmitter of the first signaling.

In one embodiment, the first node determines the specific CSI-RS according to a candidate CSI-RS indicated by the transmitter of the first signaling.

In one embodiment, the second-type target signal comprises any radio signal associated with a specific SSB which is transmitted by the transmitter of the first signaling.

In one embodiment, the first node determines the specific SSB according to a candidate SSB indicated by the transmitter of the first signaling.

In one embodiment, the first time comprises a time value.

In one embodiment, the first time is configurable.

In one embodiment, the first time is fixed.

In one embodiment, the first time takes the first time window set as a reference.

In one embodiment, the first time is an end time of the first time window set.

In one embodiment, the first time is a time before an end time of the first time window set.

In one embodiment, the first time is a start of a last time window in the first time window set.

In one embodiment, the second time window set comprises at least one time window.

In one embodiment, the second time is a time at which the first timer is started.

In one embodiment, the second time is a time after the first timer is started and before the first time.

In one embodiment, the second time is an x1-th millisecond or an x1-th sub-frame after the first timer is started and a time before the first time, where x1 is a positive integer.

In one embodiment, the second time is before the first time; the second time is unequal to the first time.

In one embodiment, the second time is a start of an i-th time window in the first time window set, where the i-th time window is a first time window that follows the starting of the first timer in the first time window set.

In one embodiment, the second time is an x2-th millisecond or an x2-th sub-frame before the first time, where x2 is a positive integer.

In one embodiment, the sentence that based on the assumption that the first signaling is not received an expiration of the first timer is used for triggering the first event includes the following meaning: if the first node hasn't received the first signaling, the expiration of the first timer will trigger the first node's execution of the first event.

In one embodiment, the sentence that based on the assumption that the first signaling is not received an expiration of the first timer is used for triggering the first event includes the following meaning: if the first node hasn't received the first signaling, and the first timer is started, the expiration of the first timer will trigger the first node's execution of the first event.

In one embodiment, the sentence that based on the assumption that the first signaling is not received an expiration of the first timer is used for triggering the first event includes the following meaning: if the first node does not receive the first signaling, and the first timer is started, the expiration of the first timer will trigger the first node's execution of the first event whether the first timer expires or not within the first time window set.

In one embodiment, the sentence that based on the assumption that the first signaling is not received an expiration of the first timer is used for triggering the first event includes the following meaning: if the first node does not transmit the first message, the expiration of the first timer will trigger the first node's execution of the first event.

In one embodiment, the sentence that based on the assumption that the first signaling is not received an expiration of the first timer is used for triggering the first event includes the following meaning: if the first signaling is not received, then after the first timer is started, the expiration of the first timer will trigger the first node's execution of the first event.

In one embodiment, the sentence that based on the assumption that the first signaling is not received an expiration of the first timer is used for triggering the first event includes the following meaning: if the first signaling is not received, it is probable that the first timer will be started, or the first timer will be expired.

In one embodiment, the first event comprises initiating a random access procedure.

In one subembodiment, the random access procedure comprises transmitting a random access signal.

In one subembodiment, the random access procedure uses a way of contention based access.

In one subembodiment, the random access procedure uses a way of contention free access.

In one subembodiment, the random access procedure uses a contention free access method, where the first signaling indicates time-frequency resources used by the contention free access method.

In one embodiment, the first event comprises transmitting a target signal.

In one embodiment, the target signal comprises a random access signal.

In one embodiment, the target signal comprises a Control Element (MAC CE).

In one embodiment, the target signal comprises an RRC message.

In one embodiment, the target signal comprises a NAS message.

In one embodiment, the target signal comprises at least one of a Preamble, or an msg1 or an msgA.

In one embodiment, the target signal comprises a scheduling request (SR).

In one embodiment, the target signal comprises a Buffer Status Report (BSR).

In one embodiment, the target signal comprises Uplink Control Information (UCI).

In one embodiment, a physical channel occupied by the target signal includes a Physical Random Access CHannel (PRACH).

In one embodiment, a physical channel occupied by the target signal includes a Physical Uplink Control Channel (PUCCH).

In one embodiment, a physical channel occupied by the target signal includes a Physical Uplink Shared Channel (PUSCH).

In one embodiment, the target signal comprises a registration update request.

In one embodiment, the target signal comprises a tracking area update.

In one embodiment, the target signal comprises a Keep Alive Message.

In one embodiment, the target signal comprises a Hybrid Automatic Repeat reQuest (HARQ) feedback.

In one embodiment, the target signal comprises a link ID update request.

In one embodiment, the target signal comprises a DIRECT LINK IDENTIFIER UPDATE REQUEST.

In one embodiment, the target signal comprises a Sidelink related discovery message.

In one embodiment, the target signal comprises positional information related to positioning.

In one embodiment, the target signal comprises a paging response.

In one embodiment, the target signal comprises RRCReconfigurationComplete.

In one embodiment, the target signal comprises RRCConnectionReconfigurationComplete.

In one embodiment, the first event comprises a radio link re-establishment caused by a radio link failure (RLF).

In one embodiment, the first event comprises a radio link reconfiguration caused by a radio link failure (RLF).

In one embodiment, the first event comprises a handover caused by a radio link failure (RLF).

In one embodiment, the first event comprises performing conditional reconfiguration.

In one embodiment, the first event comprises a Master Cell Group (MCG) failure.

In one subembodiment, the MCG failure is used to trigger a transmission of MCGfailureInformation.

In one embodiment, the first event comprises a Secondary Cell Group (SCG) failure.

In one subembodiment, the SCG failure is used to trigger a transmission of SCGfailureInformation.

In one embodiment, the first event comprises a beam failure recovery (BFR).

In one embodiment, the first event comprises transmitting a first report.

In one embodiment, the first report comprises a measurement report.

In one embodiment, the first event comprises performing a first primary measurement.

In one embodiment, the first primary measurement comprises measuring a Synchronization Signal Block (SSB).

In one embodiment, the first primary measurement comprises measuring a Channel State Information-Reference Signal (CSI-RS).

In one embodiment, the first primary measurement comprises an idle measurement.

In one embodiment, the first primary measurement comprises a CSI measurement.

In one embodiment, the first signaling is used for indicating a signal measured by the first primary measurement.

In one embodiment, the first report comprises a link failure report.

In one embodiment, the first report comprises constant Listen-Before-Talk (LBT) failure reports.

In one embodiment, the first event comprises being switched to an actual bandwidth part (BWP).

In one embodiment, the first event comprises applying a default search space.

In one embodiment, the first event comprises entering into an RRC Idle state or an RRC Inactive state.

In one embodiment, the first event comprises out-of-sync.

In one embodiment, the first event comprises performing conditional reconfiguration.

In one embodiment, the first event comprises receiving a second target signal.

In one embodiment, the second target signal comprises an SSB and/or a CSI-RS.

In one embodiment, the second target signal comprises a Positioning Reference Signal (PRS).

In one embodiment, the second target signal comprises a system message.

In one embodiment, the second target signal comprises a paging message.

In one embodiment, the second target signal comprises Downlink Control Information (DCI).

In one embodiment, the second target signal comprises Sidelink Control Information (SCI).

In one embodiment, the second target signal comprises a Random Access Response (RAR).

In one embodiment, the second target signal comprises an RRC message.

In one embodiment, the second target signal comprises a MAC CE.

In one embodiment, the second target signal comprises a system message.

In one embodiment, the second target signal comprises a NAS message.

In one embodiment, the second target signal comprises a HARQ feedback.

In one embodiment, the first event comprises transmitting a second signal; the second signal being used for indicating the first measurement result; the first node, performing a first measurement; the first measurement being used for generating a first measurement result; the action of canceling executing a first event in the second time window set comprises: the first node to cancel transmitting the second signal and discard the first measurement result.

In one embodiment, the first measurement comprises measuring a signal transmitted by the transmitter of the first signaling.

In one embodiment, the first measurement comprises measuring a signal transmitted by a node other than the transmitter of the first signaling.

In one embodiment, the first measurement comprises measuring a reference signal.

In one embodiment, the first measurement comprises measuring an SSB and/or a CSI-RS.

In one embodiment, the first measurement comprises measuring a channel quality and/or a channel status.

In one embodiment, the first measurement result comprises a Reference Signal Receiving Power (RSRP).

In one embodiment, the first measurement result comprises a Reference Signal Receiving Quality (RSRQ).

In one embodiment, the first measurement result comprises a Received Signal Strength Indication (RSSI).

In one embodiment, the first measurement result comprises a SIGNAL NOISE RATIO (SNR).

In one embodiment, the second signal comprises a measurement report.

In one embodiment, the second signal comprises the first measurement result.

In one embodiment, the sentence that “the first node to cancel transmitting the second signal and discard the first measurement result” includes the following meaning:
In one embodiment, the first node cancels transmitting the second signal;
In one embodiment, the first node discards the first measurement result;
In one embodiment, the first node does not retain or delete the first measurement result;
In one embodiment, the first node ignores any condition for triggering the second signal;
In one embodiment, the first node cancels generating the second signal;
In one embodiment, the first node postpones the first measurement.

In one embodiment, the action of canceling executing a first event in the second time window set comprises: to add the first event to the first pending list; the first node executes the first event in the first pending list at any time other than the second time window set.

In one subembodiment, the first pending list is a pending list.

In one subembodiment, the first pending list is preserved as a status variable by the first node.

In one subembodiment, the first pending list is for first-type event(s), the first-type event(s) including at least one of {initiating a random access, a small data transmission, transmitting a measurement report, performing conditional reconfiguration, transmitting an SR, transmitting a BSR, transmitting a keep alive signal, transmitting a discovery signal, transmitting a RAN notification area update, transmitting or initiating a registration update request, initiating a tracking area (TA) update request, a response paging, transmitting UE assistance information}.

In one subembodiment, the first pending list is comprised of L sub-list(s), with each respectively corresponding to L event(s) of {initiating a random access, a small data transmission, transmitting a measurement report, performing conditional reconfiguration, transmitting an SR, transmitting a BSR, transmitting a keep alive signal, transmitting a discovery signal, transmitting a RAN notification area update, transmitting or initiating a registration update request, initiating a tracking area (TA) update request, a response paging, transmitting UE assistance information}, where L is a positive integer.

In one subembodiment, the time other than the second time window set comprises the time after the first time.

In one subembodiment, the time other than the second time window set comprises the time after an end of the first time window set.

In one subembodiment, the time other than the second time window set comprises the time after delta millisecond(s) (ms) following an end of the first time window set, where delta is a positive integer.

In one subembodiment, the time other than the second time window set comprises the time after the first node's return to the network of the transmitter of the first signaling.

In one subembodiment, the first node executes the first event in the first pending list in order according to an order in which the first event is added to events in the first pending list during the time other than the second time window set.

In one subembodiment, the first node executes the first event in the first pending list in reverse order according to an order in which the first event is added to events in the first pending list during the time other than the second time window set.

In one subembodiment, the first node only executes an event last added in the first pending list according to an order in which the first event is added to events in the first pending list during the time other than the second time window set, where the first event is the event last added in the first pending list.

In one embodiment, an expiration of the first timer is used for triggering the first event.

In one embodiment, the first timer does not restart between the start of the first timer and the first time.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports transmissions in NTN.

In one embodiment, the UE 201 supports transmissions in large-delay-difference networks.

In one embodiment, the UE 201 supports V2X transmission.

In one embodiment, the UE 201 supports multiple SIMS.

In one embodiment, the UE 201 supports sidelink transmission.

In one embodiment, the UE 201 supports MBS transmission.

In one embodiment, the UE 201 supports MBMS transmission.

In one embodiment, the gNB203 corresponds to the second node in the present application.

In one embodiment, the gNB203 supports transmissions in NTN.

In one embodiment, the gNB203 supports transmissions in large-delay-difference networks.

In one embodiment, the gNB203 supports V2X transmission.

In one embodiment, the gNB203 supports sidelink transmission.

In one embodiment, the gNB203 supports MBS transmission.

In one embodiment, the gNB203 supports MBMS transmission.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first configuration message in the present application is generated by the RRC306 or a Non-Access-Stratum (NAS).

In one embodiment, the first message in the present application is generated by the PHY301, or the PHY351, or the MAC302, or the MAC352, or the RRC306 or a NAS.

In one embodiment, the first signaling in the present application is generated by the PHY301, or the PHY351, or the MAC302, or the MAC352, or the RRC306 or a NAS.

In one embodiment, the second message in the present application is generated by the MAC302, or the MAC352, or the RRC306 or a NAS.

In one embodiment, the first signal in the present application is generated by the PHY301, or the PHY351, or the MAC302, or the MAC352, or the RRC306 or a NAS.

In one embodiment, the first conditional reconfiguration in the present application is generated by the RRC306 or a NAS.

### Embodiment 4

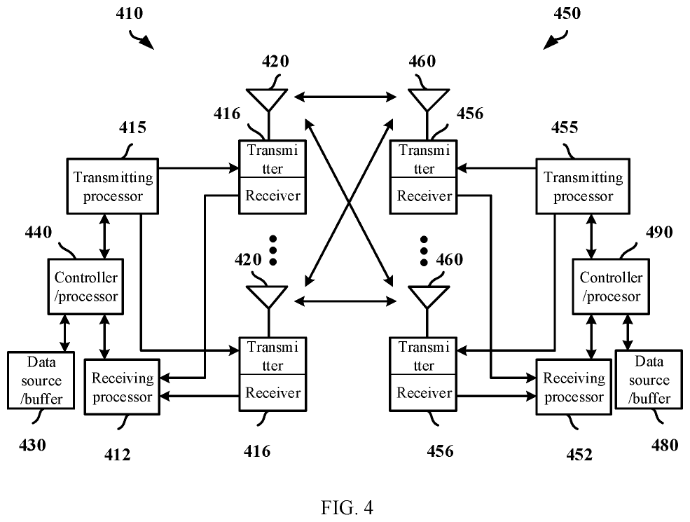

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first configuration message; the first configuration message being used for configuring a first timer; transmits a first message; the first message being used to determine a first time window set, the first time window set comprising at least one time window; and receives a first signaling; herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the first communication node 450 comprises a memory that stores a computer readable instruction program, the computer readable instruction program generates actions when executed by at least one processor, which include: receiving a first configuration message; the first configuration message being used for configuring a first timer; transmitting a first message; the first message being used to determine a first time window set, the first time window set comprising at least one time window; and receiving a first signaling; herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first configuration message; the first configuration message being used for configuring a first timer; receives a first message; the first message being used to determine a first time window set, the first time window set comprising at least one time window; and transmits a first signaling; herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the second communication device 410 comprises a memory that stores a computer readable instruction program, the computer readable instruction program generates actions when executed by at least one processor, which include: transmitting a first configuration message; the first configuration message being used for configuring a first timer; receiving a first message; the first message being used to determine a first time window set, the first time window set comprising at least one time window; and transmitting a first signaling; herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a relay.

In one embodiment, the first communication device 450 is a satellite.

In one embodiment, the first communication device 450 is an aircraft.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the second communication device 410 is an aircraft.

In one embodiment, the receiver 456 (comprising the antenna 460), the receiving processor 452 and the controller/processor 490 are used for receiving the first configuration message in the present application.

In one embodiment, the receiver 456 (comprising the antenna 460), the receiving processor 452 and the controller/processor 490 are used for receiving the first signaling in the present application.

In one embodiment, the receiver 456 (comprising the antenna 460), the receiving processor 452 and the controller/processor 490 are used for receiving the second message in the present application.

In one embodiment, the receiver 456 (comprising the antenna 460), the receiving processor 452 and the controller/processor 490 are used for receiving the first reconfiguration in the present application.

In one embodiment, the transmitter 456 (comprising the antenna 460), the transmitting processor 455 and the controller/processor 490 are used for transmitting the first message in the present application.

In one embodiment, the transmitter 456 (comprising the antenna 460), the transmitting processor 455 and the controller/processor 490 are used for transmitting the first signal in the present application.

In one embodiment, the transmitter 416 (comprising the antenna 420), the transmitting processor 412 and the controller/processor 440 are used for transmitting the first signaling in the present application.

In one embodiment, the transmitter 416 (comprising the antenna 420), the transmitting processor 412 and the controller/processor 440 are used for transmitting the second message in the present application.

In one embodiment, the transmitter 416 (comprising the antenna 420), the transmitting processor 412 and the controller/processor 440 are used for transmitting the first configuration message in the present application.

In one embodiment, the transmitter 416 (comprising the antenna 420), the transmitting processor 412 and the controller/processor 440 are used for transmitting the first conditional reconfiguration in the present application.

In one embodiment, the receiver 416 (comprising the antenna 420), the receiving processor 412 and the controller/processor 440 are used for receiving the first message in the present application.

In one embodiment, the receiver 416 (comprising the antenna 420), the receiving processor 412 and the controller/processor 440 are used for receiving the first signal in the present application.

### Embodiment 5

Embodiment 5 illustrates a flowchart of radio signal transmission according to one embodiment of the present application, as shown in FIG. 5. In FIG. 5, U01 corresponds to the first node in the present application, and N02 corresponds to the second node in the present application. It should be particularly noted that the sequence illustrated herein does not set any limit on the orders in which signals are transmitted and implementations in this present application. Herein, steps in F51 and F52 are optional.

The first node U01 receives a first conditional reconfiguration in step S5101; receives a second message in step S5102; and receives a first configuration message in step S5103; transmits first message in step S5104; and receives a first signaling in step S5105; and receives a first signal in step S5106.

The second node N02 transmits a first conditional reconfiguration in step S5201; and transmits a second message in step S5202; transmits a first configuration message in step S5203; receives a first message in step S5204; transmits a first signaling in step S5205; and receives a first signal in step S5206.

In Embodiment 5, the first configuration message is used for configuring a first timer; the first message being used to determine a first time window set, the first time window set comprising at least one time window; and the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the first node U01 is a UE.

In one embodiment, the first node U01 is a relay.

In one embodiment, the second node N02 is a UE.

In one embodiment, the second node N02 is a base station.

In one embodiment, the second node N02 is a satellite.

In one embodiment, the second node N02 is an NTN.

In one embodiment, the second node N02 is a TN.

In one embodiment, the second node N02 is a serving cell of the first node U01.

In one embodiment, the second node N02 is a Cell Group (CG) of the first node U01.

In one embodiment, the second node N02 is a primary serving cell (i.e., PCell) of the first node U01.

In one embodiment, the second node N02 is a secondary serving cell (i.e., SCell) of the first node U01.

In one embodiment, the second node N02 is an MCG of the first node U01.

In one embodiment, the second node N02 is an SCG of the first node U01.

In one embodiment, the second node N02 is a SpCell of the first node U01.

In one embodiment, an interface via which the second node N02 is in communication with the first node U01 includes Uu.

In one embodiment, an interface via which the second node N02 is in communication with the first node U01 includes PC5.

In one embodiment, the second node N02 is a Source Cell or a Target Cell of the first node U01.

In one embodiment, a communication interface between the first node U01 and the second node N02 is a Uu interface.

In one embodiment, a communication interface between the first node U01 and the second node N02 is a PC5 interface.

In one embodiment, the first node U01 has two SIMs, including a first SIM and a second SIM.

In one embodiment, the first SIM is a SIM for the second node N02; the second SIM is a SIM for a node or network other than the second node N02.

In one embodiment, the first SIM is a SIM of the second node N02 or the network of the second node N02; the second SIM is a SIM of a node other than the second node N02 or of a network other than the network of the second node N02.

In one embodiment, the second node N02 is a transmitter of the first signaling.

In one embodiment, there exists an RRC connection between the first node U01 and the second node N02.

In one embodiment, the first node U01 remains RRC Connected with the second node N02 within the first time window set.

In one embodiment, the second node N02 transmits the first signaling via a PC5 interface.

In one embodiment, the second node N02 transmits the first signaling via a Uu interface.

In one embodiment, the first conditional reconfiguration comprises an RRC message.

In one embodiment, the first conditional reconfiguration comprises a RRCReconfiguration message.

In one embodiment, the first conditional reconfiguration comprises at least partial fields in a RRCReconfiguration message.

In one embodiment, the first conditional reconfiguration comprises at least partial fields in a RRCConnectionReconfiguration message.

In one embodiment, the first conditional reconfiguration comprises at least partial fields in a RRCReconfigurationSidelink message.

In one embodiment, the first conditional reconfiguration comprises at least partial fields in a RRCSetup.

In one embodiment, the first conditional reconfiguration comprises at least partial fields in a RRCResume.

In one embodiment, the first conditional reconfiguration comprises at least partial fields in a RRCConnectionSetup.

In one embodiment, the first conditional reconfiguration comprises at least partial fields in a RRCConnectionResume.

In one embodiment, the first conditional reconfiguration comprises at least partial fields in a RRCConnectionResume.

In one embodiment, the first conditional reconfiguration comprises at least partial fields in a SIB.

In one embodiment, the first conditional reconfiguration comprises a ConditionalReconfiguration.

In one embodiment, the first conditional reconfiguration comprises at least partial fields in a ConditionalReconfiguration.

In one embodiment, the first conditional reconfiguration comprises at least partial fields in condRRCReconfig.

In one embodiment, the first node U01 cancels an evaluation of execution conditions of the first conditional reconfiguration, or, cancels an execution of the first conditional reconfiguration within the first time window set.

In one subembodiment, the first conditional reconfiguration is identified by an identity of the first conditional reconfiguration.

In one subembodiment, the first conditional reconfiguration comprises conditions of evaluating the first conditional reconfiguration.

In one subembodiment, the first conditional reconfiguration comprises conditions of executing the first conditional reconfiguration.

In one subembodiment, conditions of executing the first conditional reconfiguration include condExecutionCond.

In one subembodiment, the action of canceling an evaluation of execution conditions of the first conditional reconfiguration comprises assuming that any execution condition of the first conditional reconfiguration is not satisfied.

In one subembodiment, the action of canceling an evaluation of execution conditions of the first conditional reconfiguration comprises not evaluating whether any execution condition of the first conditional reconfiguration is satisfied.

In one subembodiment, the action of canceling an execution of the first conditional reconfiguration comprises evaluating each execution condition of the first conditional reconfiguration, but no matter whether the execution condition of the first conditional reconfiguration is satisfied, the first conditional reconfiguration is not executed.

In one subembodiment, the action of canceling an execution of the first conditional reconfiguration comprises to cancel the initiation of execution of the first conditional reconfiguration.

In one subembodiment, an execution condition of the first conditional reconfiguration comprises whether the first measurement result satisfies a given value; a transmitter of the first signaling indicates the given value.

In one embodiment, the second message comprises a first control timer, where the second message is used for indicating that when the first control timer is in a suspended state the first node U01 is allowed to transmit the first message.

In one embodiment, the second message comprises a first control timer, where the second message is used for indicating that when the first control timer is in a running state the first node U01 is forbidden from transmitting the first message.

In one embodiment, the first control timer comprises at least one of {a T304, a T310, a T312, a T316, a timer triggering L2 link ID update, a timer triggering Keep Alive}.

In one embodiment, when the first node U01 is executing a third event, the first node U01 is forbidden from transmitting the first message.

In one embodiment, only when the first node U01 is not executing a third event will the first node U01 be allowed to transmit the first message.

In one embodiment, the first node receives a third message, the third message indicating that when the first node U01 is executing a third event, the first node U01 is forbidden from transmitting the first message.

In one embodiment, the third event comprises having received a first request message, and that a first feedback message for the feedback of the first request message had not been transmitted yet.

In one subembodiment, the first request message comprises RRCReconfiguration, and the first feedback message comprises RRCReconfigurationComplete.

In one subembodiment, the first request message comprises RRCConnectionReconfiguration, and the first feedback message comprises RRCConnectionReconfigurationComplete.

In one subembodiment, the first request message comprises SecurityModeCommand, and the first feedback message comprises SecurityModeComplete.

In one embodiment, the third event comprises having transmitted a second request message, and that a second feedback message for the feedback of the second request message has not been received yet.

In one subembodiment, the second request message comprises a RRCSetupRequest, and the second feedback message comprises a RRCSetup.

In one subembodiment, the second request message comprises a RRCResumeRequest, and the second feedback message comprises a RRCResume.

In one subembodiment, the second request message comprises a RRCReestablishmentRequest, and the second feedback message comprises a RRCReestablishment.

In one subembodiment, the second request message comprises MCGFailureInformation, and the second feedback message comprises RRCReconfiguration.

In one subembodiment, the second request message comprises SCGFailureInformation, and the second feedback message comprises RRCReconfiguration.

In one subembodiment, the second request message comprises ULInformationTransfer, and the second feedback message comprises RRCReconfiguration.

In one subembodiment, the second request message comprises a REGISTRATION REQUEST, and the second feedback message comprises a REGISTRATION.

In one subembodiment, the second request message comprises a De-REGISTRATION REQUEST, and the second feedback message comprises a De-REGISTRATION.

In one embodiment, the third event comprises an occurrence of a radio link failure.

In one embodiment, the third event comprises an ongoing handover.

In one embodiment, the third event comprises an occurrence of an MCG failure.

In one embodiment, the third event comprises a HARQ retransmission being performed.

In one embodiment, the third event comprises a beam switch being performed.

In one embodiment, the third event comprises an occurrence of a beam failure.

In one embodiment, the third event comprises a BWP switch or change being performed.

In one embodiment, the third event is configurable, where the transmitter of the first signaling configures the third event.

In one embodiment, the first configuration message comprises a SIB.

In one embodiment, the first configuration message comprises RRCReconfiguration.

In one embodiment, the first message comprises UEAssistanceInformation; the first signaling comprises RRCReconfiguration.

In one subembodiment, the first node U01 transmits a RRCReconfigurationComplete message towards the second node N02 after an end of the first time window set.

In one subembodiment, the first node U01 transmits a RRCReconfigurationComplete message towards the second node N02 when the first time window set is not yet ended, and before transmitting the RRCReconfigurationComplete message, the first node initiates a random access procedure.

In one subembodiment, the first node U01 transmits a RRCReconfigurationComplete message towards the second node N02 when the first time window set is not yet ended, and before transmitting the RRCReconfigurationComplete message, the first node initiates a random access procedure, the random access procedure using Contention-free random access resources indicated by the first signaling.

In one subembodiment, the first node U01 transmits a RRCReconfigurationComplete message towards the second node N02 when the first time window set is not yet ended, and before transmitting the RRCReconfigurationComplete message, the first node transmits a first signal, the first signal comprising a random access signal.

In one embodiment, the first configuration message comprises a third timer, the third timer being expired within the first time window set; as a response to the third timer being expired, the first transmitter transmits a first signal to the transmitter of the first signaling within the first time window set.

In one subembodiment, the third timer comprises at least one of {a T304, a T310, a T312, a T321, a T322, a T380, a T316, a sCellDeactivationTimer, a beamFailureRecoveryTimer, a searchSpaceSwitchTimer, a bwp-InactivityTimer, a periodicBSR-Timer, a phr-PeriodicTimer, a lbt-FailureDetectionTimer, a timer for triggering periodic CSI reporting, a dataInactivityTimer, a timer triggering L2 link ID update, a timer triggering Keep Alive, a discardTimer of PDCP, a t-Reassembly}.

In one subembodiment, the third timer comprises at least one of {a T304, a T310, a T321, a T322, a T380, a T316, a periodicB SR-Timer, a timer for triggering periodic CSI reporting, a dataInactivityTimer, a timer triggering L2 link ID update, a timer triggering Keep Alive}.

In one embodiment, an advantage of the above method is that while a UE leaves the network with one SIM for communications with another network, if confronted with some urgent situations relevant to the previous network, the UE will have to return to the previous network to deal with the above situations to avoid disconnection from the network.

In one embodiment, the first signal comprises a random access signal.

In one embodiment, the first signal comprises a Preamble.

In one embodiment, the first signal comprises an msg1.

In one embodiment, the first signal comprises an msgA.

In one embodiment, the first signal comprises a scheduling request (SR).

In one embodiment, the first message indicates capabilities of the first node U01, or the first node transmits a message other than the first message for indicating the capabilities of the first node U01.

In one embodiment, the first message comprises at least partial fields in UECapabilityInformation.

In one embodiment, the first message indicates whether the first node U01 can receive a radio signal from the second node N02 within the first time window set with a capability being reported.

In one subembodiment, the capability being reported comprises the content contained in UE-NR-Capability.

In one subembodiment, the capability being reported means that the second node N02 can assume that the first node has a capability of continuing to receive a radio signal transmitted by the second node N02 within the first time window set.

In one subembodiment, the capability being reported means that the second node N02 does not need to change its scheduling strategies.

In one subembodiment, the capability being reported means that the second node N02 does not need to assign more time-frequency resources to the first node U01.

In one embodiment, the first message indicates that the first node U01 can receive a radio signal transmitted by the second node N02 within the first time window set with a capability previously reported.

In one subembodiment, the capability being reported includes a capability indicated by UECapabilityInformation.

In one embodiment, the first message indicates whether the first node U01 can receive a second-type target signal transmitted by the second node N02 within the first time window set.

In one embodiment, the first message indicates that the first node U01 has identical capabilities within the first time window set and outside the first time window set.

In one embodiment, the first message indicates that the second node N02 can assume that the first node U01 has identical capabilities within the first time window set and outside the first time window set.

In one embodiment, the first message indicates the first capability set, the first capability set comprising a wireless capability of the first node U01, and the first capability set being capabilities of the first node U01 within the first time window set.

In one subembodiment, the first node U01 has non-identical capabilities within the first time window set and outside the first time window set.

In one subembodiment, the first capability set at least comprises one wireless capability.

In one subembodiment, the first capability set at least comprises wireless capability/capabilities having changed compared with previously reported one(s).

In one subembodiment, the first capability set at least comprises wireless capability/capabilities having changed compared with capability/capabilities contained in UECapabilityInformation.

In one embodiment, the first message indicates that the first node U01 is equivalent to a UE with Reduced Capability (RedCap UE) in the first time window set.

In one embodiment, the first message indicates that the first node U01 is equivalent to a certain kind of UE with Reduced Capability (RedCap UE) in the first time window set.

In one embodiment, the second-type target signal comprises a radio signal bearing broadcast traffics.

In one embodiment, the second-type target signal comprises a radio signal bearing groupcast traffics.

In one embodiment, the second-type target signal comprises a radio signal bearing DCI.

In one embodiment, the second-type target signal comprises a radio signal bearing part of a DCI Format.

In one embodiment, the second-type target signal comprises a paging message.

In one embodiment, the second-type target signal comprises a RRCRelease.

In one embodiment, the second-type target signal comprises a RRCConnectionRelease.

In one embodiment, the second-type target signal comprises a SIB.

In one embodiment, the second-type target signal comprises an Earthquake and Tsunami Warning System (ETWS) signal.

In one embodiment, the second-type target signal comprises any radio signal transmitted by the second node N02.

In one embodiment, the second-type target signal comprises any radio signal associated with a specific CSI-RS which is transmitted by the second node N02.

In one embodiment, the first node U01 determines the specific CSI-RS according to a candidate CSI-RS indicated by the second node N02.

In one embodiment, the second-type target signal comprises any radio signal associated with a specific SSB which is transmitted by the second node N02.

In one embodiment, the first node U01 determines the specific SSB according to a candidate SSB indicated by the second node N02.

In one embodiment, the first configuration message comprises the second message.

In one embodiment, the second message is an information element of the first configuration message.

In one embodiment, the sentence of transmitting a first signal towards the second node N02 comprises: using resources indicated by the second node N02 for transmitting the first signal.

In one embodiment, the sentence of transmitting a first signal towards the second node N02 comprises: the first signal occupying resources of the second node N02.

In one embodiment, the sentence of transmitting a first signal towards the second node N02 comprises: the first signal using a random access sequence indicated by the second node.

### Embodiment 6

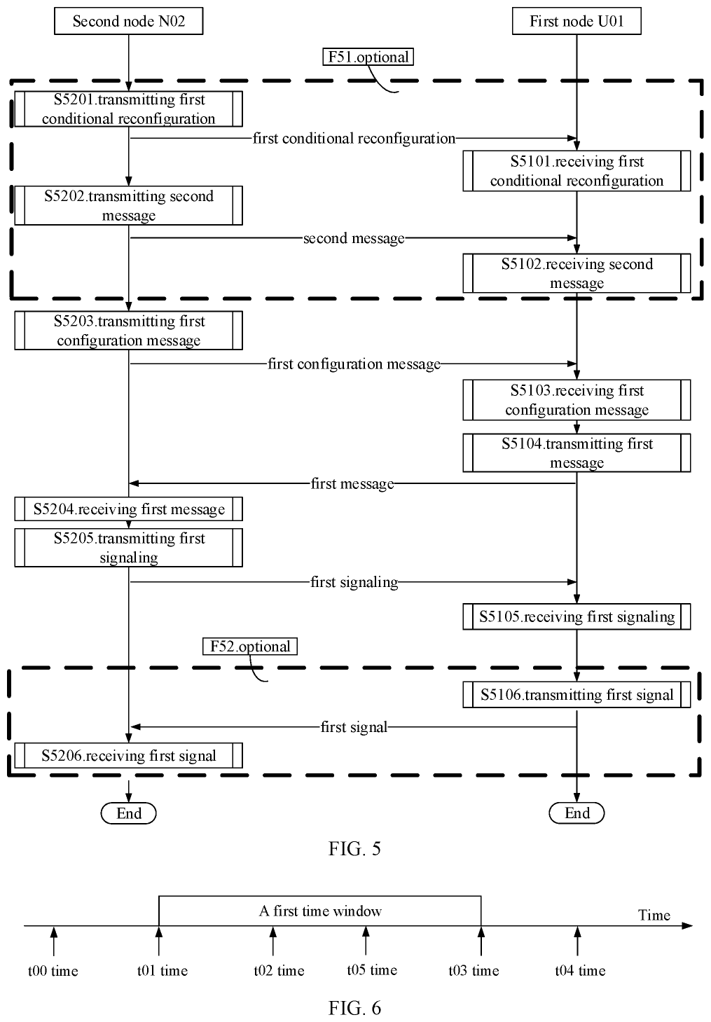

Embodiment 6 illustrates a schematic diagram of a first time window set according to one embodiment of the present application, as shown in FIG. 6.

In Embodiment 6, the first time window set only comprises a first time window; a t00 time is a time before a start of the first time window; a t01 time is a start of the first time window; a t02 time and a t05 time are two times after a start of the first time window and before an end of the first time window; a t03 time is an end of the first time window; a t04 time is a time after an end of the first time window. It should be noted that geometric distances mutually between the t00 time, the t01 time, the t02 time, the t03 time, and the t04 time shown in FIG. 6 do not imply exact time intervals among them; for instance, in FIG. 6, that the distance between the t03 time and the t04 time is smaller than the distance between the t02 time and the t03 time does not necessary mean that a time interval between the t02 time and the t03 time is larger than a time interval between the t03 time and the t04 time.

In one embodiment, a transmission time of the first message is the t00 time.

In one embodiment, a transmission time of the first message is the t01 time.

In one embodiment, a reception time of the first signaling is the t00 time.

In one embodiment, a reception time of the first signaling is the t01 time.

In one embodiment, the first time window comprises T time units, where the time unit includes at least one of {millisecond, second, an OFDM symbol, a slot, a mini-slot, a sub-frame, a frame, a hyper-frame, minute, a periodicity of Discontinuous Reception (DRX), a paging periodicity, a periodicity of modification, a system message periodicity}.

In one embodiment, a start of the first timer includes at least one of {the t00 time, the t01 time, the t02 time, the t05 time}.

In one embodiment, a start of the first timer is one of {the t00 time, the t01 time, the t02 time, the t05 time}.

In one embodiment, the first time includes at least one of {the t02 time, the t05 time, the t03 time, the t04 time}.

In one embodiment, the first time is one of {the t02 time, the t05 time, the t03 time, the t04 time}.

In one embodiment, the first time is one of {the t02 time, the t05 time, the t03 time}.

In one embodiment, if the first timer starts with the t01 time, the first time is one of {the t02 time, the t05 time, the t03 time, the t04 time}.

In one embodiment, if the first timer starts with the t02 time, the first time is one of {the t03 time, the t04 time}.

In one embodiment, if the first timer starts with the t02 time, the first time is the t03 time.

In one subembodiment, a time interval between the t02 time and the t03 time is larger than an expiration value of the first timer.

In one embodiment, if the first timer starts with the t02 time, the first time is the t04 time.

In one subembodiment, a time interval between the t02 time and the t04 time is larger than an expiration value of the first timer.

In one embodiment, an expiration value time of the first timer after the start of the first timer is before the first time.

In one embodiment, assuming that the first timer is not intervened after being started, the time of expiration of the first timer is before the first time.

In one subembodiment, if the first timer starts with the t02 time and the first time is a t03 time, assuming that the first timer is not intervened after being started, an expiration time of the first timer is between the t02 time and the t03 time.

In one embodiment, an expiration value time of the first timer after a start time of the first timer is the second time.

In one embodiment, the first timer starts with the t02 time, assuming that the first timer is not suspended or reset or modified in its expiration value after being started, the expiration time of the first timer is the t02 time, and the second time is the t05 time or a time after the t05 time and before the first time.

In one subembodiment, the first time is the t03 time, and the second time is the t05 time or a time between the t05 time and the t03 time.

In one embodiment, an advantage of the above method is that when a possible expiration time of the first timer is within the first time window set, the above method can be used for avoidance of the influence brought about by the first timer's expiration on the first node within the first time window set.

### Embodiment 7

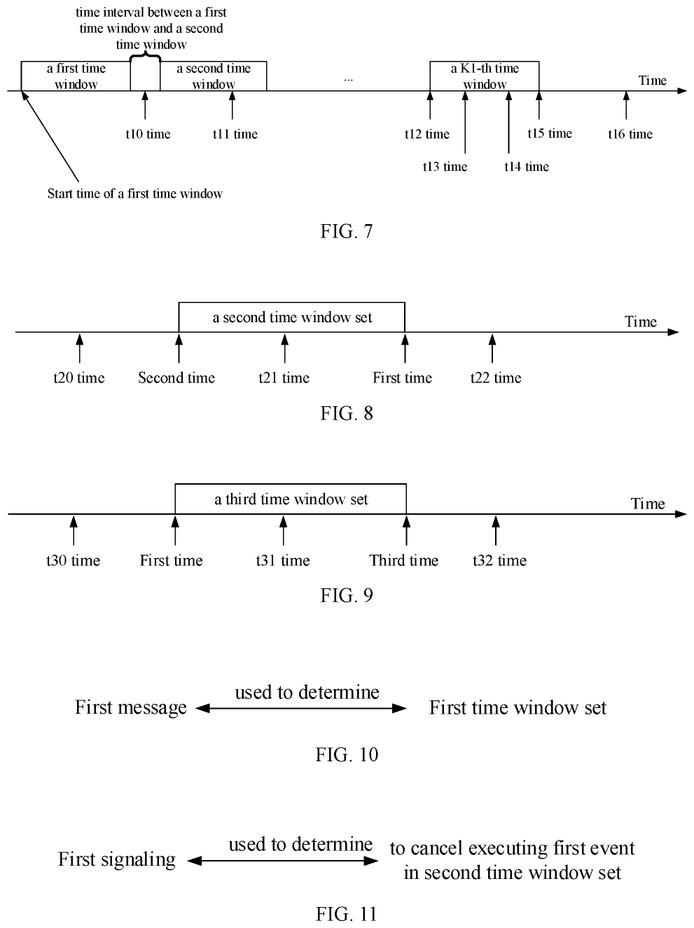

Embodiment 7 illustrates a schematic diagram of a first time window set according to one embodiment of the present application, as shown in FIG. 7.

In Embodiment 7, the first time window set comprises K1 time windows, K1 being a positive integer greater than 1; a t10 time is a time between a first time window among the K1 time windows and a second time window among the K1 time windows; a t11 time is a time within a second time window among the K1 time windows; a t12 time is a start of a K1-th time window among the K1 time windows; a t13 time and a t14 time are times within a K1-th time window among the K1 time windows; a t15 time is an end of a K1-th time window among the K1 time windows; a t16 time is a time after an end of a K1-th time window among the K1 time windows. It should be noted that geometric distances mutually between the t10 time, the t11 time, the t12 time, the t13 time, the t14 time, the t15 time and the t16 time shown in FIG. 7 do not imply exact time intervals among them.

In one embodiment, K1 is infinity.

In one embodiment, K1 is finite.

In one embodiment, intervals mutually between the K1 time windows are of equal lengths.

In one embodiment, intervals mutually between the K1 time windows are of unequal lengths.

In one embodiment, intervals mutually between the K1 time windows are no smaller than a slot.

In one embodiment, lengths of all time windows among the K1 time windows are of equal lengths.

In one embodiment, there are at least time windows of unequal lengths among the K1 time windows.

In one embodiment, each of intervals mutually between the K1 time windows is larger than a length of a shortest time window among the K1 time windows.

In one embodiment, a length of each of the K1 time windows is measured in time.

In one embodiment, a length of each time window among the K1 time windows is no smaller than a slot.

In one embodiment, a possible start time of the first timer includes at least one of {the t10 time, the t11 time, the t12 time, the t13 time, the t14 time}; a value of the first time includes at least one of {the t11 time, the t12 time, the t13 time, the t14 time, the t15 time, the t16 time}; and a start time of the first timer is earlier than the first time.

In one embodiment, a start time of the first timer is a t10 time, assuming that the first timer is not intervened, an expected expiration time of the first timer is one of {the t11 time, the t12 time, the t13 time, the t14 time}, the second time is one of {the t11 time, the t12 time, the t13 time, the t14 time}, and the first time is one of {the t12 time, the t13 time, the t14 time, the t15 time, the t16 time}; and the second time is earlier than the first time, and the second time is no earlier than an expected expiration time of the first timer without being intervened.

In one subembodiment, an expected expiration time of the first timer is a t13 time; the second time is a t14 time; the first time is a t15 time.

In one subembodiment, the first time is an end of the K1 time windows; the second time is an expiration value time of the first timer after a start time of the first timer.

In one embodiment, a start time of the first timer is a t13 time, and a time interval between the t13 time and the t14 time is an expiration value of the first timer, where the second time is the t14 time, and the first time is the t15 time.

In one embodiment, the first signaling is used to indicate the start time of a first time window among the K1 time windows.

In one embodiment, a reception time of the first signaling or a sub-frame following the reception time of the first signaling is the start time of a first time window among the K1 time windows.

In one embodiment, the first signaling indicates intervals mutually between time windows among the K1 time windows.

In one embodiment, the first signaling indicates lengths of time windows among the K1 time windows.

In one embodiment, the first signaling indicates the K1.

In one embodiment, the first message comprises the K1.

### Embodiment 8

Embodiment 8 illustrates a schematic diagram of a second time window set according to one embodiment of the present application, as shown in FIG. 8.

In one embodiment, the second time window set at least comprises one time window, where a length of time window(s) comprised in the second time window set is equal to or larger than a slot.

In one embodiment, the second time window set at least comprises time-domain resources of one slot.

In one embodiment, the second time window set is a subset of the first time window set.

In one embodiment, FIG. 8 is only used for illustrating a start time and an end time of the second time window set.

In one embodiment, the second time window set equals T1 time unit(s), where the time unit includes one of {millisecond, second, an OFDM symbol, a slot, a mini-slot, a sub-frame, a frame, a hyper-frame, minute, a periodicity of DRX, a paging periodicity, a periodicity of modification, a system message periodicity}.

In one subembodiment, T1 is a positive real number.

In one subembodiment, T1 is a positive integer.

In one embodiment, a t20 time in FIG. 8 is a time before a start of the second time window set; a second time in FIG. 8 is a start time of the second time window set; a t21 time in FIG. 8 is a time in the second time window set; a first time in FIG. 8 is an end time of the second time window set; a t22 time in FIG. 8 is a time after an end of the second time window set.

In one embodiment, a start of the first timer is the t20 time.

In one embodiment, a start of the first timer is the t20 time; a time interval between the t20 time and the second time is an expiration value of the first timer.

In one embodiment, a start of the first timer is the t20 time; assuming that there is no intervention, an expected expiration time of the first timer is the second time.

In one embodiment, an end time of the first time window set is the first time.

In one embodiment, an end time of the first time window set is the t21 time.

In one embodiment, an end time of the first time window set is the t22 time.

### Embodiment 9

Embodiment 9 illustrates a schematic diagram of a third time window set according to one embodiment of the present application, as shown in FIG. 9.

In one embodiment, the third time window set at least comprises one time window, where a length of any time window comprised in the third time window set is at least larger than a slot.

In one embodiment, the third time window set at least comprises time-domain resources of one slot.

In one embodiment, the third time window set is a subset of the first time window set.

In one embodiment, a complement of the intersection of the third time window set and the first time window set is not empty.

In one embodiment, the third time window set and the first time window set are orthogonal in time domain.

In one embodiment, the third time window set comprises the second time window set.

In one embodiment, an end of the first time window is a start of the third time window set.

In one embodiment, FIG. 9 is only used for illustrating a start time and an end time of the third time window set.

In one embodiment, the third time window set equals T2 time unit(s), where the time unit includes one of {millisecond, second, an OFDM symbol, a slot, a mini-slot, a sub-frame, a frame, a hyper-frame, minute, a periodicity of DRX, a paging periodicity, a periodicity of modification, a system message periodicity}.

In one subembodiment, T2 is a positive real number.

In one subembodiment, T2 is a positive integer.

In one embodiment, a t30 time in FIG. 9 is a time before a start of the third time window set; a first time in FIG. 9 is a start time of the third time window set; a t31 time in FIG. 9 is a time in the third time window set; a third time in FIG. 9 is an end time of the third time window set; a t32 time in FIG. 9 is a time after an end of the third time window set.

In one embodiment, the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than the first expiration time; the first expiration time is a time determined by the expiration value of the second timer after starting of the second timer.

In one embodiment, the second timer includes at least one of {a T304, a T310, a T312, a T321, a T322, a T380, a T316, a sCellDeactivationTimer, a beamFailureRecoveryTimer, a searchSpaceSwitchTimer, a bwp-InactivityTimer, a periodicB SR-Timer, a phr-PeriodicTimer, a lbt-FailureDetectionTimer, a timer for triggering periodic CSI reporting, a dataInactivityTimer, a timer triggering L2 link ID update, a timer triggering Keep Alive, a discardTimer of PDCP, a t-Reassembly}.

In one embodiment, the first threshold comprises T3 time unit(s), where the time unit includes one of {millisecond, second, an OFDM symbol, a slot, a mini-slot, a sub-frame, a frame, a hyper-frame, minute, a periodicity of DRX, a paging periodicity, a periodicity of modification, a system message periodicity}.

In one subembodiment, T3 is a positive real number.

In one subembodiment, T3 is a positive integer.

In one embodiment, a transmitter of the first signaling configures an expiration value of the second timer.

In one embodiment, the first signaling is used for configuring an expiration value of the second timer.

In one embodiment, an expiration value of the second timer is equal to an expiration value of the first timer.

In one embodiment, an expiration value of the second timer is greater than an expiration value of the first timer.

In one embodiment, the sentence that the first expiration time is a time determined by the expiration value of the second timer after starting of the second timer comprises the following meaning: assuming that the second timer is free from any intervention after being started, the expiration time of the second timer is the first expiration time.

In one embodiment, the sentence that the first expiration time is a time determined by the expiration value of the second timer after starting of the second timer comprises the following meaning: assuming that the second timer is not reset or suspended or extended after being started, the expiration time of the second timer is the first expiration time.

In one embodiment, the sentence that the first expiration time is a time determined by the expiration value of the second timer after starting of the second timer comprises the following meaning: a time interval between a start time of the second timer and the first expiration time is the expiration value of the second timer.

In one embodiment, the first expiration time is the third time.

In one embodiment, the first expiration time is the t32 time.

In one embodiment, an end time of the first time window set is earlier than the third time.

In one embodiment, an end time of the first time window set is the first time.

In one embodiment, the first signaling explicitly indicates that executing a second event is canceled in a third time window set.

In one embodiment, the second event comprises initiating a random access procedure.

In one subembodiment, the random access procedure comprises transmitting a random access signal.

In one subembodiment, the random access procedure uses a way of contention based access.

In one subembodiment, the random access procedure uses a way of contention free access.

In one subembodiment, the random access procedure uses a contention free access method, where the first signaling indicates time-frequency resources used by the contention free access method.

In one embodiment, the second event comprises transmitting a target signal.

In one embodiment, the second event comprises a radio link re-establishment caused by a radio link failure (RLF).

In one embodiment, the second event comprises a radio link reconfiguration caused by a radio link failure (RLF).

In one embodiment, the second event comprises a handover caused by a radio link failure (RLF).

In one embodiment, the second event comprises performing conditional reconfiguration.

In one embodiment, the second event comprises a Master Cell Group (MCG) failure.

In one subembodiment, the MCG failure is used to trigger a transmission of MCGfailureInformation.

In one embodiment, the second event comprises a Secondary Cell Group (SCG) failure.

In one subembodiment, the SCG failure is used to trigger a transmission of SCGfailureInformation.

In one embodiment, the second event comprises a beam failure recovery (BFR).

In one embodiment, the second event comprises transmitting a first report.

In one embodiment, the first report comprises a measurement report.

In one embodiment, the second event comprises performing a first primary measurement.

In one embodiment, the first primary measurement comprises measuring a Synchronization Signal Block (SSB).

In one embodiment, the first primary measurement comprises measuring a Channel State Information-Reference Signal (CSI-RS).

In one embodiment, the first primary measurement comprises an idle measurement.

In one embodiment, the first primary measurement comprises a CSI measurement.

In one embodiment, the first signaling is used for indicating a signal measured by the first primary measurement.

In one embodiment, the first report comprises a link failure report.

In one embodiment, the first report comprises constant Listen-Before-Talk (LBT) failure reports.

In one embodiment, the second event comprises being switched to an actual bandwidth part (BWP).

In one embodiment, the second event comprises applying a default search space.

In one embodiment, the second event comprises entering into an RRC Idle state or an RRC Inactive state.

In one embodiment, the second event comprises out-of-sync.

In one embodiment, the second event comprises performing conditional reconfiguration.

In one embodiment, the second event comprises receiving a second target signal.

In one embodiment, assuming that the first signaling is not received, an expiration of the second timer will trigger the second event.

In one embodiment, assuming that the first message is not transmitted or is not received by a transmitter of the first signaling, an expiration of the second timer will trigger the second event.

In one embodiment, the first signaling is used to determine that executing a second event is canceled in a third time window set.

In one embodiment, the first signaling indicates the first threshold, and a time length from a start of the second timer to the first time exceeds a difference between an expiration value of the second timer and the first threshold, then the first node cancels executing the second event in a third time window set.

In one embodiment, a start time of the second timer is the t30 time, where a time interval between the t30 time and the t32 time is the first threshold; a time interval between the t30 time and the third time is an expiration value of the second timer, and then the first node cancels executing the second event in a third time window set.

In one embodiment, the action of canceling executing the second event comprises that: the first node terminates the execution of the second event.

In one embodiment, the action of canceling executing the second event comprises that: the first node does not start the execution of the second event.

In one embodiment, the action of canceling executing the second event comprises that: the first node stops the second timer.

In one embodiment, the action of canceling executing the second event comprises that: the first node suspends the second timer or suspends an update of the second timer.

In one embodiment, the action of canceling executing the second event comprises that: the first node reconfigures the second timer.

In one embodiment, the action of canceling executing the second event comprises that: the first node restarts the second timer.

In one embodiment, the action of canceling executing the second event comprises that: the first node ignores the expiration of the second timer.

In one embodiment, the action of canceling executing the second event comprises that: the first node extends the second timer.

In one embodiment, the action of canceling executing the second event comprises that: the first node adds the second event in the first pending list, and the second event is not executed within the third time window set.

### Embodiment 10

Embodiment 10 illustrates a schematic diagram of a first message being used to determine a first time window set according to one embodiment of the present application, as shown in FIG. 10.

In one embodiment, the first time window set comprises one time window.

In one embodiment, the first time window set comprises K1 time windows, where K1 is a positive integer greater than 1.

In one embodiment, the first message comprises the first time window set.

In one subembodiment, the first message indicates K1.

In one subembodiment, the first message indicates a length of each time window comprised in the first time window set.

In one subembodiment, the first message indicates time intervals mutually between time windows comprised in the first time window set.

In one subembodiment, the first message indicates a total length of time windows comprised in the first time window.

In one subembodiment, the first message indicates a shortest length of one of time windows comprised in the first time window.

In one subembodiment, the first message indicates proportional relations among lengths of time windows comprised in the first time window.

In one subembodiment, the first message indicates a relative trajectory of motion of the first node, the trajectory of motion being used to determine the first time window set.

In one subembodiment, the first message indicates a minimum transmission delay, the minimum transmission delay being used to determine a length of the first time window set.

In one subembodiment, the first message indicates a maximum transmission delay, the maximum transmission delay being used to determine a length of the first time window set.

In one subembodiment, the first message indicates the cause of requesting that a wireless transmission for a transmitter of the first signaling be suspended in the first time window set, the cause being used to determine an event required to be executed, where the event required to be executed is used to determine the first time window.

In one subembodiment, the first message indicates a start time of the first time window set.

In one embodiment, the first message triggers the first signaling, the first signaling indicating the first time window set.

In one subembodiment, the first signaling indicates K1.

In one subembodiment, the first signaling indicates a length of each time window comprised in the first time window set.

In one subembodiment, the first signaling indicates time intervals mutually between time windows comprised in the first time window set.

In one subembodiment, the first signaling indicates a total length of time windows comprised in the first time window.

In one subembodiment, the first signaling indicates a shortest length of one of time windows comprised in the first time window.

In one subembodiment, the first signaling indicates proportional relations among lengths of time windows comprised in the first time window.

In one subembodiment, the first signaling indicates a relative trajectory of motion of the first node, the trajectory of motion being used to determine the first time window set.

In one subembodiment, the first message indicates a minimum transmission delay, the minimum transmission delay being used to determine a length of the first time window set; the length of the first time window set satisfies the minimum transmission delay.

In one subembodiment, the first message indicates a maximum transmission delay, the maximum transmission delay being used to determine a length of the first time window set; the length of the first time window set satisfies the maximum transmission delay.

In one subembodiment, the first message indicates the cause of requesting that a wireless transmission for a transmitter of the first signaling be suspended in the first time window set, the cause being used to determine an event required to be executed, where the event required to be executed is used to determine the first time window.

In one subembodiment, the first signaling indicates a start time of the first time window set.

In one embodiment, the first message and the first signaling are used together for determining the first time window set.

In one subembodiment, the first message indicates a length of the first time window set, while the first signaling indicates a start time of the first time window set.

In one subembodiment, the first message indicates the cause of requesting that a wireless transmission for a transmitter of the first signaling be suspended in the first time window set, where the first signaling indicates a length of the first time window.

In one embodiment, the first message explicitly indicates the first time window set.

In one embodiment, the first message triggers the first signaling, the first signaling explicitly indicating the first time window set.

### Embodiment 11

Embodiment 11 illustrates a schematic diagram of a first signaling being used to determine that executing a first event is canceled in a second time window set according to one embodiment of the present application, as shown in FIG. 11.

In one embodiment, the first signaling explicitly indicates that executing a first event is canceled in a second time window set.

In one embodiment, the first signaling explicitly indicates a condition for canceling executing a first event in a second time window set.

In one embodiment, the first signaling indicates an updated expiration value of the first timer; when a time length from a start of the first timer to a first time exceeds the expiration value of the first timer but does not exceed the updated expiration value of the first timer, the first node cancels executing a first event in the second time window set.

In one embodiment, the first signaling indicates an updated expiration value of the first timer; when a time length from a start of the first timer to a first time exceeds the expiration value of the first timer and meanwhile exceeds the updated expiration value of the first timer, the first node cancels executing a first event in the second time window set.

In one embodiment, the first signaling indicates an updated expiration value of the first timer; when a time length from a start of the first timer to a first time does not exceed the expiration value of the first timer but exceeds the updated expiration value of the first timer, the first node cancels executing a first event in the second time window set.

In one embodiment, the first signaling indicates an updated expiration value of the first timer; when a time length from a start of the first timer to a first time exceeds the updated expiration value of the first timer, the first node cancels executing a first event in the second time window set.

In one embodiment, the first signaling indicates the second time window set.

In one embodiment, the first signaling indicates a first time.

In one embodiment, the first signaling indicates a second time.

In one embodiment, the first signaling indicates that when the first timer belongs to a first-type timer set, a time length from a start of the first timer to a first time exceeds an expiration value of the first timer, and the start of the first timer is before the first time; the first signaling is used to determine that executing a first event is canceled in a second time window set.

In one subembodiment, the first-type timer set comprises at least one of {a T304, a T310, a T312, a T321, a T322, a T380, a T316, a sCellDeactivationTimer, a beamFailureRecoveryTimer, a searchSpaceSwitchTimer, a bwp-InactivityTimer, a periodicB SR-Timer, a phr-PeriodicTimer, a lbt-FailureDetectionTimer, a timer for triggering periodic CSI reporting, a dataInactivityTimer, a timer triggering L2 link ID update, a timer triggering Keep Alive, a discardTimer of PDCP, a t-Reassembly}.

In one subembodiment, the first-type timer set comprises at least one of {a T304, a T310, a T312, a T316, a timer triggering L2 link ID update, a timer triggering Keep Alive}.

In one subembodiment, the first-type timer set only comprises timer(s) other than {a phr-PeriodicTimer, a discardTimer of PDCP, a t-Reassembly}.

In one subembodiment, the first-type timer set only comprises timer(s) other than {a beamFailureRecoveryTimer, a searchSpaceSwitchTimer, a lbt-FailureDetectionTimer}.

In one subembodiment, the first-type timer set only comprises timer(s) other than {a sCellDeactivationTimer}.

In one subembodiment, the first-type timer set only comprises timer(s) other than {a T321, a T322, a T380, a periodicBSR-Timer}.

In one subembodiment, the first-type timer set only comprises timer(s) other than {a searchSpaceSwitchTimer, a bwp-InactivityTimer}.

In one embodiment, the action of canceling executing the first event comprises that: the first node terminates the execution of the first event.

In one embodiment, the action of canceling executing the first event comprises that: the first node does not start the execution of the first event.

In one embodiment, the action of canceling executing the first event comprises that: the first node stops the first timer.

In one embodiment, the action of canceling executing the first event comprises that: the first node suspends the first timer or suspends an update of the first timer.

In one embodiment, the action of canceling executing the first event comprises that: the first node reconfigures the first timer.

In one embodiment, the action of canceling executing the first event comprises that: the first node restarts the first timer.

In one embodiment, the action of canceling executing the first event comprises that: the first node ignores the expiration of the first timer.

In one embodiment, the action of canceling executing the first event comprises that: the first node extends the first timer.

In one embodiment, the action of canceling executing the first event comprises that: the first node adds the first event in the first pending list, and the first event is not executed within the second time window set.

In one embodiment, the action of canceling executing the first event comprises that: the first node adds the first event in the first pending list, and the first event is not executed within the first time window set.

In one embodiment, the action of canceling executing the first event comprises that: the first node adds the first event in the first pending list, and the first node executes the first event in the first waiting event only during the time after an end of the second time window set.

In one embodiment, the action of canceling executing the first event comprises that: the first node adds the first event in the first pending list, and the first node executes the first event in the first waiting event only during the time after an end of the first time window set.

### Embodiment 12

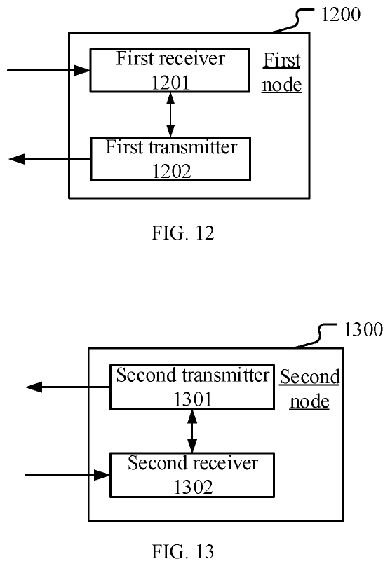

Embodiment 12 illustrates a structure block diagram of a processing device used in a first node according to one embodiment of the present application; as shown in FIG. 12. In FIG. 12, a processing device 1200 in a first node is comprised of a first receiver 1201 and a first transmitter 1202. In Embodiment 12,
the first receiver 1201 receives a first configuration message and a first signaling; the first configuration message being used for configuring a first timer;
the first transmitter 1202 transmits a first message; the first message being used to determine a first time window set, the first time window set comprising at least one time window;
herein, the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the first receiver 1201 receives a second message, the second message comprising a first control timer, where the second message is used for indicating that when the first control timer is in a suspended state the first node is allowed to transmit the first message.

In one embodiment, the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than a first expiration time; the first expiration time is a time determined by the expiration value of the second timer after starting of the second timer.

In one embodiment, the first configuration message comprises a third timer, the third timer being expired within the first time window set;
as a response to the third timer being expired, transmitting a first signal to the transmitter of the first signaling within the first time window set.

In one embodiment, the first event comprises transmitting a second signal; the second signal being used for indicating the first measurement result;
the first receiver 1201 performs a first measurement; the first measurement being used for generating a first measurement result;
the action of canceling executing a first event in the second time window set comprises: the first receiver 1201 to cancel transmitting the second signal and discard the first measurement result.

In one embodiment, the first receiver 1201 receives a first conditional reconfiguration;
the first receiver 1201 cancels an evaluation of execution conditions of the first conditional reconfiguration, or, canceling an execution of the first conditional reconfiguration within the first time window set.

In one embodiment, the action of canceling executing a first event in the second time window set comprises: to add the first event to the first pending list;
the first transmitter 1202 executes the first event in the first pending list at any time other than the second time window set.

In one embodiment, the first node is a UE.

In one embodiment, the first node is a terminal supporting large delay difference.

In one embodiment, the first node is a terminal supporting NTN.

In one embodiment, the first node is an aircraft.

In one embodiment, the first node is a vehicle-mounted terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a piece of equipment supporting transmissions with low delay and high reliability.

In one embodiment, the first node is a multicast-supporting node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

### Embodiment 13

Embodiment 13 illustrates a structure block diagram of a processing device used in a second node according to one embodiment of the present application; as shown in FIG. 13. In FIG. 13, a processing device 1300 in a second node is comprised of a second transmitter 1301 and a second receiver 1302. In Embodiment 13,
the second transmitter 1301 transmits a first configuration message and a first signaling; the first configuration message being used for configuring a first timer;
the second receiver 1302 receives a first message; the first message being used to determine a first time window set, the first time window set comprising at least one time window;
herein, the first message is used for requesting that a wireless transmission for the second node 1300 be suspended in the first time window set; the first signaling is used for indicating an acceptance of the request of the first message; a time length from a start of the first timer to a first time exceeds an expiration value of the first timer, where the start of the first timer is before the first time; the first signaling is used by a transmitter of the first message to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

In one embodiment, the second transmitter 1301 transmits a second message, the second message comprising a first control timer, where the second message is used for indicating that when the first control timer is in a suspended state the transmitter of the first message is allowed to transmit the first message.

In one embodiment, the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used by the transmitter of the first message to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than a first expiration time; the first expiration time is a time determined by the expiration value of the second timer after starting of the second timer.

In one embodiment, the first configuration message comprises a third timer, the third timer being expired within the first time window set;
as a response to the third timer being expired, the transmitter of the first message transmits a first signal to the second node 1300 within the first time window set.

In one embodiment, the first event comprises transmitting a second signal; the second signal being used for indicating the first measurement result;
the transmitter of the first message performs a first measurement; the first measurement being used for generating a first measurement result;
the action of canceling executing a first event in the second time window set comprises: the transmitter of the first message to cancel transmitting the second signal and discard the first measurement result.

In one embodiment, the second transmitter 1301 transmits a first conditional reconfiguration;
the transmitter of the first message, canceling an evaluation of execution conditions of the first conditional reconfiguration, or, canceling an execution of the first conditional reconfiguration within the first time window set.

In one embodiment, the action of canceling executing a first event in the second time window set comprises: to add the first event to the first pending list;
the transmitter of the first message executes the first event in the first pending list at any time other than the second time window set.

In one embodiment, the second node is a satellite.

In one embodiment, the second node is a UE.

In one embodiment, the second node is an IoT node.

In one embodiment, the second node is a wearable node.

In one embodiment, the second node is a base station.

In one embodiment, the second node is a relay.

In one embodiment, the second node is an access point.

In one embodiment, the second node is a multicast-supporting node.

In one embodiment, the second node is a satellite.

In one embodiment, the second transmitter 1301 comprises at least one of the antenna 420, the transmitter 418, the transmitting processor 416, the multi-antenna transmitting processor 471, the controller/processor 475 or the memory 476 in Embodiment 4.

In one embodiment, the second receiver 1302 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment, eNB (LTE node B), test equipment like transceiving device simulating partial functions of base station or signaling tester.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first configuration message and a first signaling; the first configuration message being used for configuring a first timer; and
a first transmitter, transmitting a first message, the first message being used to determine a first time window set, the first time window set comprising at least one time window;
wherein the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

2. The first node according to claim 1, characterized in that
the first timer does not restart between the start of the first timer and the first time.

3. The first node according to claim 1, comprising:
the first receiver, receiving a second message, the second message comprising a first control timer, where the second message is used for indicating that when the first control timer is in a suspended state the first transmitter is allowed to transmit the first message.

4. The first node according to claim 2, comprising:
the first receiver, receiving a second message, the second message comprising a first control timer, where the second message is used for indicating that when the first control timer is in a suspended state the first transmitter is allowed to transmit the first message.

5. The first node according to claim 1, characterized in that
when the first node is executing a third event, the first node is forbidden from transmitting the first message.

6. The first node according to claim 1, characterized in that
the first event comprises a Master Cell Group (MCG) failure.

7. The first node according to claim 1, characterized in that
the first event comprises a beam failure recovery (BFR).

8. The first node according to claim 1, comprising:
the first receiver, performing a first measurement; the first measurement being used for generating a first measurement result;
wherein the first event comprises transmitting a second signal; the second signal being used for indicating the first measurement result; the action of canceling executing a first event in the second time window set comprises: to cancel transmitting the second signal and discard the first measurement result.

9. The first node according to claim 2, comprising:
the first receiver, performing a first measurement; the first measurement being used for generating a first measurement result;
wherein the first event comprises transmitting a second signal; the second signal being used for indicating the first measurement result; the action of canceling executing a first event in the second time window set comprises: to cancel transmitting the second signal and discard the first measurement result.

10. The first node according to claim 1, comprising:
the first receiver, receiving a first conditional reconfiguration; and
the first receiver, canceling an evaluation of execution conditions of the first conditional reconfiguration, or, canceling an execution of the first conditional reconfiguration within the first time window set.

11. The first node according to claim 1, comprising:
the first transmitter, executing the first event in the first pending list at any time other than the second time window set;
wherein the action of canceling executing a first event in the second time window set comprises: to add the first event to the first pending list.

12. The first node according to claim 2, comprising:
the first transmitter, executing the first event in the first pending list at any time other than the second time window set;
wherein the action of canceling executing a first event in the second time window set comprises: to add the first event to the first pending list.

13. The first node according to claim 1, characterized in that
the first configuration message indicates a second timer and a first threshold, a time length from a start of the second timer to the first time exceeds a difference between an expiration value of the second timer and the first threshold, where the start of the second timer is before the first time; the first threshold is a positive number;
the first signaling is used to determine that executing a second event is canceled in a third time window set, based on the assumption that the first signaling is not received an expiration of the second timer is used for triggering the second event, where the third time window set comprises time-domain resources between the first time and a third time; the third time is no earlier than the first time, and the third time is no later than a first expiration time; the first expiration time is a time determined by the expiration value of the second timer after starting of the second timer.

14. The first node according to claim 1, comprising:
the first transmitter, as a response to the third timer being expired, transmitting a first signal to the transmitter of the first signaling within the first time window set;
wherein the first configuration message comprises a third timer, the third timer being expired within the first time window set.

15. The first node according to claim 1, characterized in that
the first time window set comprises K1 time windows, K1 being a positive integer greater than 1.

16. The first node according to claim 1, characterized in that
the first message indicates that the first node can only receive a second-type target signal transmitted by the transmitter of the first signaling within the first time window set.

17. The first node according to claim 11, characterized in that
the first message indicates that the first node can only receive a second-type target signal transmitted by the transmitter of the first signaling within the first time window set.

18. The first node according to claim 1, characterized in that
there exists an RRC connection between the first node and the transmitter of the first signaling.

19. A second node for wireless communications, comprising:
a second transmitter, transmitting a first configuration message and a first signaling; the first configuration message being used for configuring a first timer;
a second receiver, receiving a first message, the first message being used to determine a first time window set, the first time window set comprising at least one time window;
wherein the first message is used for requesting that a wireless transmission for the second node be suspended in the first time window set; the first signaling is used for indicating an acceptance of the request of the first message; a time length from a start of the first timer to a first time exceeds an expiration value of the first timer, where the start of the first timer is before the first time; the first signaling is used by a transmitter of the first message to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.

20. A method in a first node for wireless communications, comprising:
receiving a first configuration message; the first configuration message being used for configuring a first timer; and
transmitting a first message, the first message being used to determine a first time window set, the first time window set comprising at least one time window; and
receiving a first signaling;
wherein the first message is used for requesting that a wireless transmission for a transmitter of the first signaling be suspended in the first time window set; the first signaling is used for indicating an acceptance of the request of the first message; a time length from a start of the first timer to a first time exceeds an expiration value of the first timer, where the start of the first timer is before the first time; the first signaling is used to determine that executing a first event is canceled in a second time window set, based on the assumption that the first signaling is not received an expiration of the first timer is used for triggering the first event, the second time window set comprising time-domain resources between a second time and the first time, where the second time is between the start of the first timer and the first time and a time length from the second time to the start of the first timer is no smaller than the expiration value of the first timer.
